(19) United States
(12) Patent Application Publication
(10) Pub. No.: US 2015/0013536 A1
(43) Pub. Date: Jan. 15, 2015

(54) Gas Removal System for Offshore and Onshore Oil and Liquid Product Pipelines

(71) Applicant: Multiphase Engineering Corporation, Albuquerque, NM (US)

(72) Inventors: Yuri FAIRUZOV, Albuquerque, NM (US); Victor FAIRUZOV, Albuquerque, NM (US)

(21) Appl. No.: 14/329,053

(22) Filed: Jul. 11, 2014

Related U.S. Application Data
(60) Provisional application No. 61/845,308, filed on Jul. 11, 2013.
(60) Provisional application No. 61/846,946, filed on Jul. 16, 2013.

(51) Int. Cl. B01D 19/00

(52) U.S. Cl. CPC B01D 19/0042
USPC 95/1; 96/156; 96/174

(57) ABSTRACT

Provided herein are methods and devices for removing gas from pipelines, including offshore and/or onshore pipelines at pipeline locations where gases have a tendency to accumulate. In an aspect the pipeline contains a hydrocarbon-containing liquid containing undissolved and/or non-condensable gases which tend to form corrosive gases that adversely affect pipeline performance and/or integrity. A pump specially positioned with respect to pump inlet and pump outlet in pipeline sections are used to increase fluid velocity in pipeline sections where gas can accumulate. Optionally, a valve is employed to facilitate fluid recirculation upon detection of a gas bubble that causes a change in a pressure drop in the pipeline from the expected hydrostatic pressure drop.

### CROSS REFERENCE TO RELATED APPLICATIONS

This application claims the benefit of priority from U.S. Provisional Patent Application Nos. 61/845,308 filed Jul. 11, 2013, and 61/846,946 filed Jul. 16, 2013, each of which is hereby incorporated by reference in its entirety to the extent not inconsistent herewith.

### FIELD OF INVENTION

Aspects of the disclosure relates to oil, oil/water, and liquid hydrocarbon products (condensate, LPG, diesel, gasoline, kerosene, jet fuel) and transfer devices and processes. More specifically, provided herein are various devices which remove corrosive gases from offshore and onshore pipelines. Additional advantages of the methods and devices are that they reduce the pump power required to transport crude oil and products in pipelines.

### BACKGROUND OF INVENTION

In offshore oil pipelines, gas pockets tend to form in the export risers (extending from the outlet of the process equipment down towards the sea floor), as shown in FIG. 1. Backpressure on the upstream facilities increases dramatically, if a large enough gas pocket is allowed to form in the export riser. This increase in backpressure can reduce the well production rate or require large and costly to operate transfer pumps.

The presence of non-condensable gases and/or low flow velocities may lead to the formation of large gas bubbles or pockets in sections with downward slopes in subsea and onshore hilly-terrain pipelines, as shown in FIG. 2. The gas in the pocket is saturated with water vapor that can condensate at the upper portion of the pipe and cause top of line corrosion. Accordingly, there is a need in the art to reliably detect and dissipate such

The gas eliminator proposed in the U.S. Pat. No. 5,294,214 includes the following disadvantages: (1) Can only be used for offshore pipelines; (2) Does not remove gas from the subsea line (see FIG. 2 of U.S. Pat. No. 5,294,214); (3) Requires removal of liquid accumulated in the gas tubing (see FIG. 3 of U.S. Pat. No. 5,294,214) due to condensation of water and heavy fractions of the associated gas, otherwise the system will not work because the gas riser in the import platform is filled with liquid. The methods and devices of the present invention address the above-identified limitations.

### SUMMARY OF THE INVENTION

Gas pockets (large gas bubbles) are formed in inclined downward sections of pipelines carrying liquids where the liquid velocity is less than bubble-rise velocity and the transported liquid contains a small amount of undissolved gas. The liquid velocity required to sweep out gas depends on the size of the bubbles. Provided herein are methods and apparatus to remove gas pockets trapped in pipelines by increasing the local liquid velocity to a velocity exceeding the gas sweep out velocity in the pipeline sections where gas is accumulated in an elegant, reliable, and cost effective manner. A method for predicting the gas sweep out velocity is provided for vertical or near vertical downward flow, e.g. flow in the riser of an offshore export platform. The method takes into account by what fluid the riser is initially filled, liquid or gas.

Provided herein are methods and systems that detect and remove gas from pipeline sections where it is accumulated, such as gas pockets arising from low liquid velocity and trapped in pipeline sections having elevation changes. For this purpose, a recirculating conduit is used to increase the local liquid velocity to a velocity sufficient to sweep or dislodge gas from the section. Typical applications of the methods and systems provided herein include, but are not limited to: offshore oil (product) pipelines, pipelines transporting liquid from elevated separators, and hilly-terrain, onshore pipelines transporting liquids.

Also provided herein are specially configured pipelines to ensure any gas pocket formation is contained in a precise location within the pipeline by incorporating specially configured pipeline inclinations fluidically adjacent to inclined sections, such as an export riser. This is beneficial for constraining gas pocket to select locations and to minimize or avoid gas pocket migration or growth in an upstream direction. Accordingly, any of the systems and methods provided herein may utilize such an upstream incline section of pipeline.

In an embodiment, the invention is an apparatus for removing gas from a liquid hydrocarbon in an inclined section of a pipeline. The apparatus comprises a recirculating fluid conduit comprising an inlet connected to the pipeline at a downstream position relative to the inclined section; an outlet connected to an upstream position relative to the inclined section; a pump operably connected to the recirculating fluid conduit to provide a flow of recirculating fluid through the inclined section. The recirculating fluid is provided from the pipeline to the recirculating fluid conduit inlet and introduced to the pipeline at the recirculating fluid conduit outlet. A sensor is operably connected to the inclined section for determining the presence or absence of a gas pocket in the inclined section. The recirculating fluid is introduced to the pipeline from the recirculating fluid conduit in the presence of a gas pocket in the inclined section to increase flow-rate through the inclined section and to sweep away the gas pocket. The pipeline is a liquid hydrocarbon transporting pipeline and the inclined section has a downwardly inclined configuration.

In an aspect, the pump is positioned in the recirculating fluid conduit for controlling a flow rate through the recirculating fluid conduit.

In an aspect, the pump is a shipping pump positioned in the pipeline that pumps a flow of a liquid hydrocarbon through the pipeline, the recirculating fluid conduit further comprising: a valve to control a flow of recirculating fluid through the recirculating fluid conduit; wherein the recirculating fluid conduit outlet is configured to provide the flow of recirculating fluid through the recirculating fluid conduit to an inlet of the shipping pump.

In an embodiment, the pump is positioned between the recirculating fluid conduit outlet and the incline section of the pipeline.

The fluid inlet and fluid outlet may be positioned flush with an inner surface of the pipeline.

The apparatus is compatible with any number of sensor configurations, such as for a gas pocket that is at least partially positioned between pressure sensors. In this aspect, the sensor may comprise a first pressure sensor and a second pressure sensor, wherein the first and second pressure sensors are positioned so that any gas pocket in the inclined section is captured in a pipeline region that is between the first and second pressure sensors. The first pressure sensor may be connected upstream of the inclined section and the second pressure sensor may be connected at a point within the inclined section or at a position downstream of the inclined section.

In an embodiment, the first pressure sensor is connected to an upper portion of the pipeline at an inlet end of the inclined section; and the second pressure sensor is connected to or adjacent with an outlet end of the inclined section.

In an aspect, the first and second pressure sensors are positioned in an adjacent upstream region relative to the inclined section; wherein the adjacent upstream region is substantially horizontal and fluidically connects a pipeline riser section with the inclined section; and the first and second pressure sensors opposibly face each other with the first pressure sensor connected to a lower portion of the pipeline and the second pressure sensor connected to an upper portion of the pipeline and any gas pocket in the inclined section is at least partially trapped between the opposibly facing first and second pressure sensors. The first and second pressure sensors may be connected to a differential manometer or a U-tube manometer, and the pipeline has an operating pressure that is less than 400 psi.

Any of the sensors described herein may be selected from the group consisting of: a pressure sensor; a flow sensor; a U-tube manometer; a capacitance probe; a manometer; and any combination thereof.

In an embodiment, the sensor comprises a user-detected or calculated value of an operating parameter and a switch for turning the flow of recirculating fluid: on when the user-detected or calculated value is less than a user-selected value of the operating parameter; or off when the user user-detected or calculated value is greater than a user-selected value of the operating parameter.

The operating parameter may be selected from the group consisting of: liquid hydrocarbon flow rate through the pipeline; pressure difference between a first pressure sensor and a second pressure sensor; and in situ liquid hold-up.

In an aspect, the user-selected value is a calculated gas bubble sweep out velocity or flow rate and the user-detected value is a produced liquid hydrocarbon velocity or flow rate. In this manner, the system can identify the presence of a gas pocket and a corresponding sweep out velocity determined. The pump and valves may be engaged so as to provide a sufficient flow of fluid through the recirculating fluid conduit to at least achieve or exceed the sweep out velocity or flow rate, thereby removing the gas pocket. As necessary, the pump may be ramped up to further excess the sweep out velocity, such as exceeding by at least 10%, 20% or 40%, so as to ensure removal of any gas pocket.

In an aspect, the sensor measures in-situ liquid holdup in a horizontal section of the pipeline that is upstream of the downward inclined section of the pipeline where a gas accumulates, such as to form a gas pocket. In an aspect, the in-situ liquid holdup is measured by a sensor that is a retractable capacitance probe.

Any of the apparatus provided herein may comprise a plurality of sensors to detect presence or absence of a gas pocket in the inclined section.

To avoid gas pocket migration to an upstream facility, the apparatus may further comprise an upward inclined section of pipeline between the recirculating fluid conduit outlet and the inclined section of pipeline. The inclined section may comprise a riser section and a substantially horizontal pipeline section, the horizontal pipeline section fluidically connects the riser section and the upward inclined section, wherein the substantially horizontal pipeline section is horizontal or has an inclination angle that is up to about −0.1° so as to confine any gas pocket to the inclined section.

The invention is compatible with a range of liquid hydrocarbon transporting pipelines, including offshore pipelines and/or onshore pipelines. The pipeline inclined section may correspond to a pipeline export riser or a pipeline import riser.

The apparatus may be further described in terms of any one or more physical parameters, such as a pipeline having: a diameter between 20 cm and 91 cm, an upward inclined section inclination angle sufficient to provide an elevation change between an entry and an exit of the upward inclined section that is greater than the pipe diameter; a pressure in the pipeline between 50 kPa and 1000 kPa; and/or a fluid flow-rate of between 3500 bpd and 230000 bpd to remove a gas pocket.

In an aspect, at the outlet end of the inclined section the liquid hydrocarbon has a hydrostatic head, P_{H}, corresponding to P_{H}=ρgh, wherein ρ is the fluid density, g is the acceleration due to gravity, and h is a vertical distance between the first and second pressure sensors. A gas pocket may be detected for a drop in pressure head compared to a no gas pocket condition, wherein the drop exceeds 10% of a minimum pressure head corresponding to the pipeline completely filled with liquid hydrocarbon.

The devices and methods provided herein facilitate controlled increase in flow-rates to dislodge and remove gas pockets. Accordingly, the invention may be described in terms of bolus increase in flow-rates for certain gas pocket detection conditions. In an embodiment, the recirculating fluid increases flow-rate through the pipeline incline section by between about 20% to 30% compared to a flow-rate through the pipeline incline section when no gas pocket is present.

The systems provided herein are compatible with a wide range of pipeline configurations and attendant gas pocket formation and dissipation. In an aspect, a gas pocket in the pipeline to be removed has a volume selected from a range that is greater than or equal to 0.01 m³ and less than or equal to 23 m³.

In an embodiment, upon gas pocket detection, the gas pocket is removed from the incline section at a removal time selected from a range that is greater than or equal to 60 seconds and less than or equal to 30 minutes.

In various embodiments, the recirculating fluid conduit has: a diameter that is greater than or equal to 10 cm and less than or equal to 30 cm; a diameter ratio relative to the pipeline diameter: 0.3<(D_{conduit}/Dₚᵢₚₑₗᵢₙₑ)<0.8; a length that is greater than or equal to 20 m and less than or equal to 150 m; and/or a length ratio relative to the inclined section height: 1.2<(L_{conduit}/H_{incline})<4.

The recirculating fluid conduit may be rigid and permanently connected to the pipeline and formed from a material selected from the group consisting of: stainless steel, carbon steel with a high density polyurethane internal coating, and corrosion resistant alloy.

Also provided herein are various methods for removing a gas pocket trapped in an inclined section of a liquid hydrocarbon transporting pipeline. The method may comprise the steps of: detecting a gas pocket in the inclined section; introducing a flow of recirculating fluid to a recirculating fluid conduit, wherein the introduced flow of recirculating fluid is at a position downstream of the gas pocket; and introducing the flow of recirculating fluid from the recirculating fluid conduit to the pipeline at a position that is upstream of the gas pocket to increase a flowrate through the inclined section, thereby removing the gas pocket from the inclined section. In an aspect, the increased flowrate may correspond to a flowrate that is greater than or equal to a calculated or predetermined flowrate necessary to remove the gas pocket. To provide a buffer, the increased flowrate may exceed such calculated predetermined flow rates by about 10%, 20% or 30% to ensure gas pocket removal

The method may further comprise the detecting step that comprises: calculating a predicted gas sweep out value rate; observing a hydrocarbon liquid production rate; and introducing the flow of recirculating fluid to the recirculating fluid conduit for a predicted gas pocket condition corresponding to an observed hydrocarbon liquid production rate that is less than a predicted gas sweep out value rate. The method may further comprise the step of: stopping the flow of recirculating fluid the recirculating fluid conduit for a predicted no gas pocket condition corresponding to the observed hydrocarbon liquid production rate that is greater than or equal to the predicted gas sweep out value rate.

In an aspect, the detecting comprises: measuring a pressure in the inclined section; and identifying a gas pocket in the inclined section when the measured pressure drop differs from a pressure drop corresponding to a no gas pocket condition by at least 10%; wherein the pressure drop corresponding to a no gas pocket condition is a pressure head whose value relates to the height of liquid in the pipeline above the location where the pressure is measured.

In an aspect, the detecting comprises: calculating a pressure drop across at least a portion of the inclined section by measuring a first pressure at a first pipeline position and a second pressure at a second pipeline position, wherein the second pipeline position is downstream from the first pipeline position; and identifying a gas pocket present condition between the first and second pipeline positions when the calculated pressure drop deviates from an expected pressure head corresponding to ρgh by at least 10%, wherein ρ is the fluid density, g is the acceleration due to gravity, and h is the vertical distance between the first pipeline position and the second pipeline position.

Any of the methods and devices herein may introduce the recirculating fluid into the pipeline to increase a fluid flow-rate of fluid in the pipeline compared to a corresponding fluid flow-rate without introduced recirculating fluid by at least a factor of 1.2. As necessary, this factor may be increased further in the event the fluid flow-rate increase is insufficient to dislodge the gas pocket. Accordingly, the procedure may be iterative, with increased flow-rate followed by further monitoring and, if necessary, another increase in flow-rate that may be higher than the previous step-increase, with repeated bolus increases as necessary until the gas pocket is dislodged.

The step of introducing the flow of recirculating fluid to a recirculating fluid conduit may comprises: opening a flow control valve in the recirculating fluid conduit; and engaging a pump to flow recirculating fluid through the recirculating fluid conduit and into the pipeline at the position upstream from the inclined pipeline section.

The pump may be positioned in the recirculating fluid conduit or positioned in the pipeline and downstream of the introduced flow of recirculating fluid from the recirculating fluid conduit to the pipeline.

Also provided herein are methods of confining any gas pocket in the pipeline by providing a section of pipeline that is inclined upward, wherein the inclined upward pipeline section has an upper-most portion positioned between the point at which the flow of recirculating fluid from the recirculating fluid conduit is introduced to the pipeline and an upper-most portion of the inclined section pipeline.

The methods may be implemented in a pipeline that is an offshore pipeline or an onshore pipeline.

The inclined section may be an export riser or an import riser having a vertical height that is greater than or equal to 10 m and less than or equal to 120 m. The recirculating fluid conduit may have a length that is greater than or equal to 20 m and less than or equal to 400 m.

In an aspect, the calculated gas sweep out value rate is:

$${v}_{s} = 0.347 \sqrt{gD ( 1 - \frac{{ρ}_{g}}{{ρ}_{l}} )} ;$$

for a gas pocket that fills an entire cross-section of the pipeline; or

$${v}_{s} = {1.53 [ \frac{g {σ}_{L} ( {ρ}_{L} - {ρ}_{g} )}{{ρ}_{L}^{2}} ]}^{1 / 4}$$

for a gas pocket having a size that is less than a diameter of the pipeline.

νₛ is the gas sweep out value rate (m/s), g is the acceleration due to gravity (m/s²), D is the diameter of the pipeline interior (m), ρ_{g} is gas density (kg/m³), and ρₗ is liquid density (kg/m³); and the flow rate, q_{b}, through the inclined section is calculated as: q_{b}=vₛ*(πD²/4), wherein at least a portion of the flow through the inclined section is from the recirculating fluid conduit.

Also provided are methods of installing an apparatus for removing gas from an inclined section of a liquid hydrocarbon transporting pipeline into a liquid hydrocarbon transporting pipeline. Such a method may be considered a retrofit of an existing pipeline and is commercially practical given the functional benefits of the instant invention's gas pocket removal and attendant reduction in corrosion problems. The method may comprise the steps of: providing a recirculating fluid conduit having a first end and a second end; connecting the first end of the recirculating fluid conduit to the pipeline at a position upstream of the inclined section; connecting the second end of the recirculating fluid conduit to the pipeline at a position downstream of the inclined section; providing at least one pressure sensor to measure pressure in the pipeline, wherein the measured pressure indicates the presence or absence of a gas pocket in the inclined section; and providing a flow-controller to control a flow-rate of recirculating fluid through the recirculating fluid conduit. Appropriate flow-controllers include components operably connected to affect fluid flow, such as pumps, valves, switches and the like.

Such flow-controllers may be used in any of the methods and apparatuses provided herein. In an aspect, the flow-controller comprises a pump that controls the flow-rate of recirculating fluid through the recirculating fluid conduit. The flow controller is operably connected to an output of the pressure sensor to: automatically generate recirculating fluid flow through the recirculating fluid conduit when the measured pressure in the pipeline deviates from a user-selected tolerance value; and automatically stop recirculating fluid flow through the recirculating fluid conduit when the measured pressure in the pipeline is within a user-selected tolerance value. The tolerance level may correspond to a measured pressure that is within 10% of a pressure for a no gas pocket condition.

The method may further comprise installing an inclined upward section of pipeline between first end of the recirculating fluid conduit and the inclined section of the pipeline to confine any gas pockets to a pipeline region that is downstream from the first end of the recirculating fluid conduit. As discussed, the pipeline may be an offshore or onshore pipeline.

In an aspect, any of the methods and devices provided herein calculate a gas sweep out velocity required to remove gas pockets. Any the devices may comprise a controller that fluidically controls flow-rate in the recirculating fluid conduit to automatically provide an appropriate level of fluid flow in the recirculating loop to increase fluid velocity in the region of the gas pocket, such as the inclined section, thereby ensuring gas pocket dislodgment.

The invention also includes a device for practicing any of the methods described herein. The invention may also be an apparatus that embodies any of the methods described herein.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1. Gas pocket in the export riser of an offshore oil pipeline.

FIG. 2. Gas pocket in an oil pipeline.

FIG. 3. System to remove gas from export riser.

FIG. 4. System to remove gas from export riser and subsea pipeline.

FIG. 5. System to remove gas from onshore oil pipelines.

FIG. 6. System to remove gas from export riser.

FIG. 7. A. Illustration of system with pressure sensor arranged across a pipeline cross-section. B. Cross-sectional view of the opposibly configured pressure sensors.

FIG. 8. System similar to that of FIG. 7, but with the pump positioned in the recirculating fluid conduit.

FIG. 9. Illustration of a system with an oil tank storage or separator.

FIG. 10. System for removing gas pockets from a section of a transfer pipeline.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

“Inclined section” is used broadly herein to refer to pipeline sections having elevation changes and that may either be a cause of gas pocket formation or be a location where gas pockets may become trapped. Accordingly, the inclined section may be an import or an export riser. An inclined section may also correspond to pipeline sections undergoing elevation changes and so that may tend to collect and trap gas, and, therefore, may be vulnerable to corrosion and corresponding pipeline weakness, leakage and failure. An inclined section may be further described as having a “downwardly inclined configuration”

“Sweep away” refers to a fluid velocity that is sufficient to dislodge a gas pocket in a pipeline location. As discussed, the sweep away velocity is dependent on gas pocket properties, including size such as whether gas phase completely fills the pipeline cross-section or if there is some liquid phase present. Provided herein are various mathematical relationships that can be used to calculate the sweep out or away velocity.

“Fluidically connected” refers to a configuration of elements, wherein the fluid can flow from or between one element and another without adversely affecting the functionality of the elements and without substantial leakage.

“Operably connected” refers to a configuration of elements, wherein an action or reaction of one element affects another element, but in a manner that preserves each element's functionality. For example, the action of a pump, valve, and conduit that together facilitates reliable flow-rates and/or stops fluid flow are characterized as operably connected.

“In situ liquid hold-up” refers to an event in the pipeline, such as a gas pocket, the acts to prevent or hinder flow characteristics through the pipeline and may be quantified in terms of a sensor output, such as from a capacitance probe along with physical characteristics of the pipeline. Liquid holdup, or in-situ liquid volume fraction, may also be obtained from one of the multiphase flow correlations, and depends on several parameters including the gas and liquid flow-rates, and the pipe diameter.

“Adjacent” refers to a portion of the pipeline that is spatially near another portion. For example, a pressure sensor that is adjacent to an outlet may be described as being within a certain distance of the outlet, such as within about three pipeline diameters or less of the outlet.

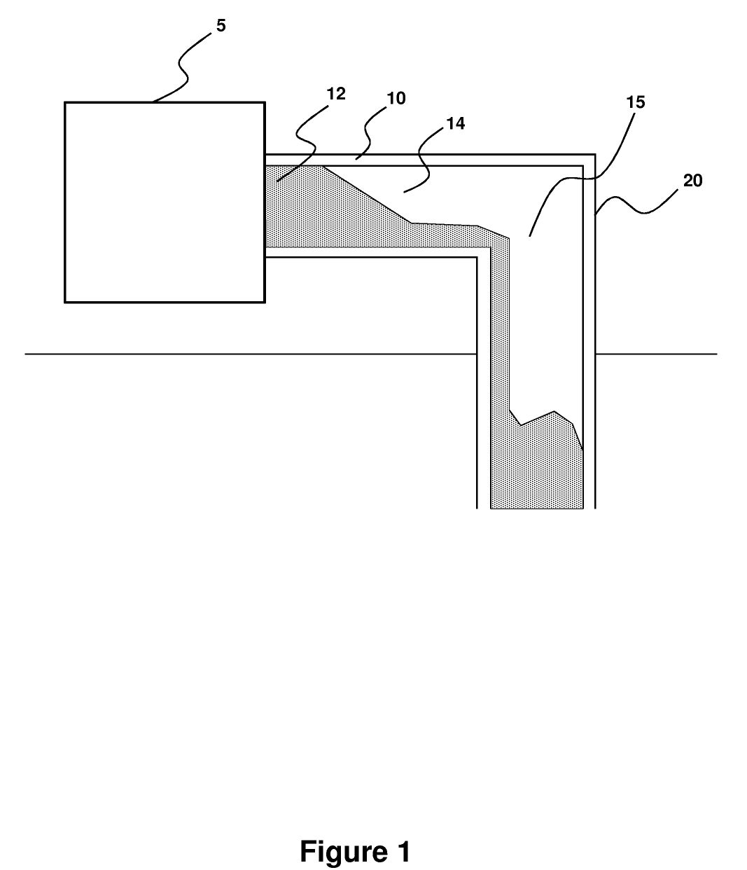

FIG. 1 is a schematic of a pipeline 10 fluidically connected to an off-shore hydrocarbon liquid production facility 5. Facility 5 is characterized as positioned in an upstream location. Pipeline 10 may be a liquid hydrocarbon transporting pipeline, with the liquid hydrocarbon transported in the pipeline comprising a multiphase fluid having a liquid phase 12 and a gas phase 14. Due to the presence of inclined section 20, the gas phase 14 may form a gas bubble or gas pocket 15 confined to at least a portion of an inclined section 20 and areas adjacent thereto as gas pocket formation increases in size.

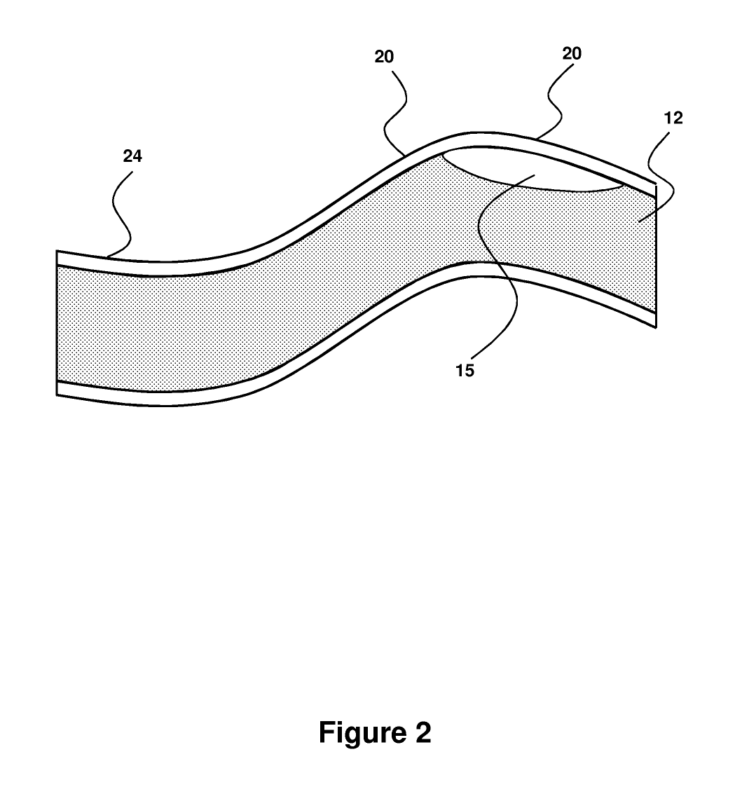

Similar kinds of gas pockets may form in any liquid-containing pipeline having inclined sections, as illustrated in FIG. 2, including an on-shore pipeline. FIG. 2 illustrates other geometries of inclined section 20, including pipeline sections having positive and negative inclinations and other sections that are horizontal 24 so that gas pocket 15 is trapped in specific pipeline regions. The methods and apparatus provided herein facilitate gas pocket detection and gas pocket removal. Various examples are provided hereinbelow, and include useful specific embodiments of the present invention, but are non-limiting in nature as it will be apparent to one skilled in the art that the present invention may be carried out using a large number of variations of the devices, device components and method steps set forth in the present description.

### Example 1

### Pressure Drop Measurement Along a Pipeline

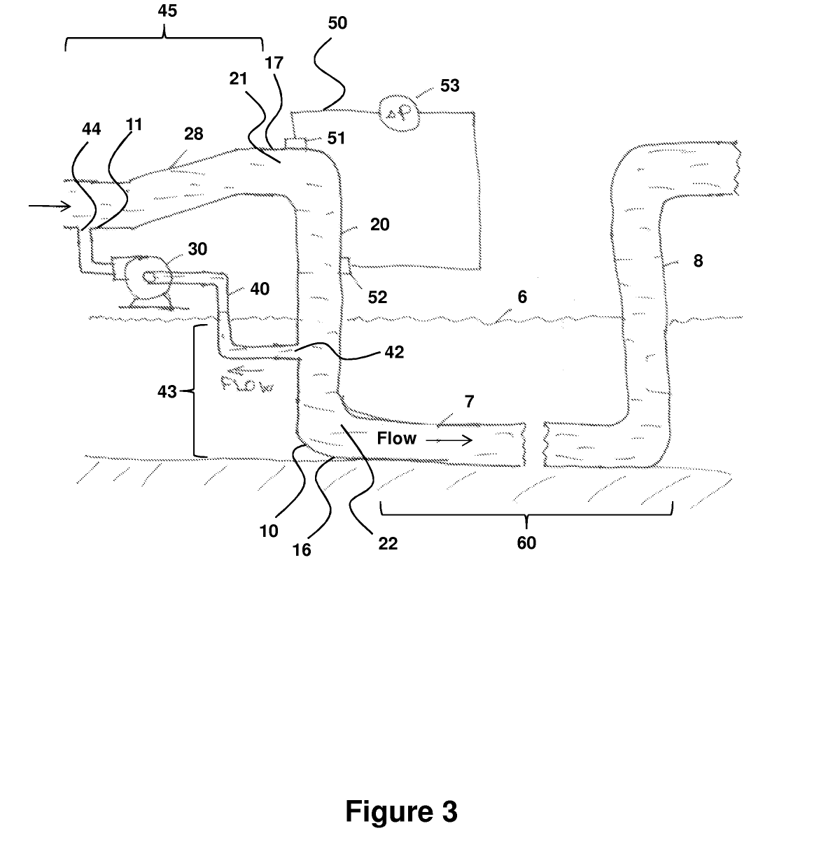

Referring to FIGS. 3-5, in an embodiment any of the methods and devices are for use with a pipeline 10 such as a hydrocarbon-containing pipeline that may be beneath the water surface 6. The pipeline may comprise an inclined section (e.g., export riser) 20 and/or 8 (e.g., import riser), a pump 30, a recirculating fluid conduit 40, a section inclined upwards 28, also referred herein as a pipeline riser section, upstream of the export riser, a differential pressure sensor 50, for example pressure sensors 51 and 52, and differential manometer (transducer) 53. When the pressure difference measured by the differential pressure sensor (e.g., manometer) 50 is less than hydrostatic pressure drop corresponding to the condition, at which the export riser is completely filled with liquid, the pump 30 is engaged to provide liquid recirculation and an increase in the flow velocity in the riser required to sweep out the accumulated gas. Once the measured pressure drop reaches the value corresponding to the liquid hydrostatic pressure drop, the pump is turned off. The upward inclined section 28 is used to avoid gas bubble migration to the facilities upstream of the device provided herein, as well as unwanted cavitation in the pump.

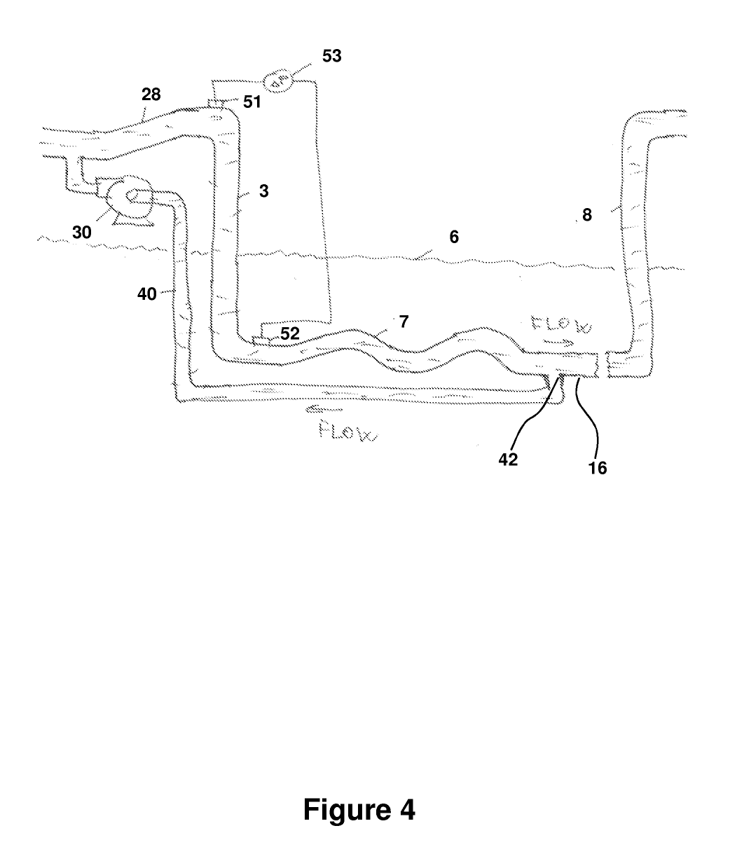

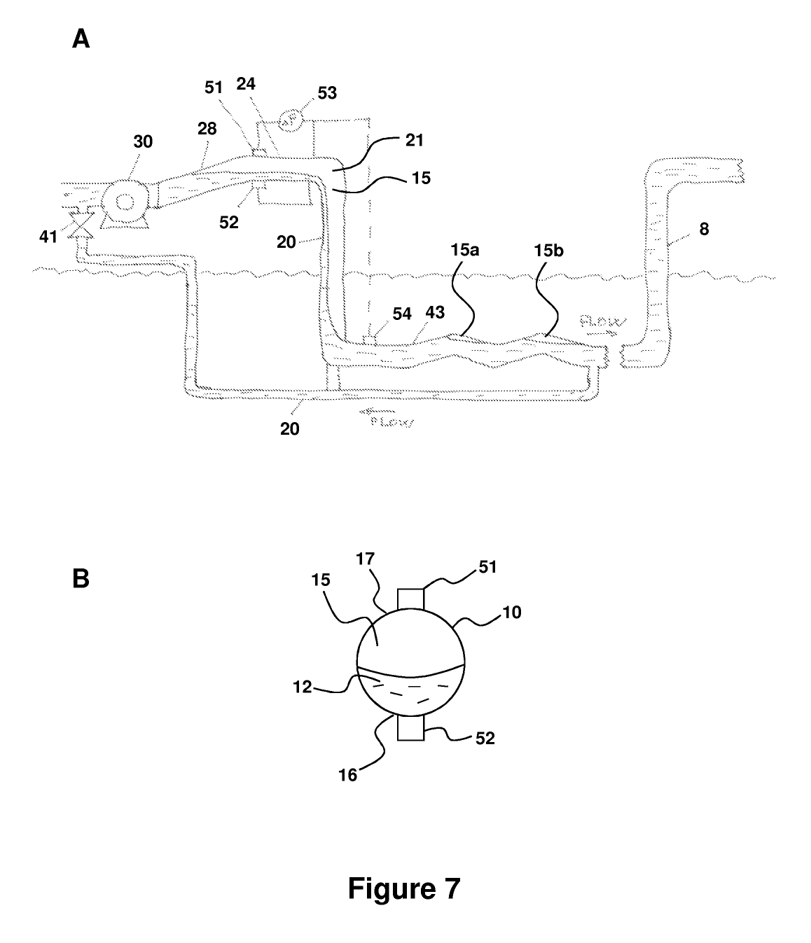

The recirculating fluid conduit 40 has an inlet 42 and an outlet 44. The inlet may be positioned in a pipeline downstream position 43 or 60. The outlet may be positioned in a pipeline upstream position 45. Positions 43 and 45 are indicated as variable, in that the instant invention is compatible with various relative positions of the inlet and outlet in the pipeline, so long as functionally, the recirculating fluid via conduit 40 provides an increase in fluid velocity in the pipeline incline section 20 so as to sweep out a gas pocket formed in and around the pipeline incline section 20. Examples of gas pocket 15 in and around the incline section is illustrated, for example, in FIG. 7. The inlet 42 and outlet 42 may be connected flush with an inner surface 11 of the pipeline 10. Inclined section 20 may be further defined as having an inlet end 21 and an outlet end 22, along with pipeline lower portion 16 and upper portion 17 (see also FIG. 7B). A downstream portion 60 of the pipeline may be substantially horizontal (FIGS. 3, 6 and 9) or have elevation changes (FIGS. 4, 5, 7, 8 and 9).

FIG. 4 illustrates a system designed to remove corrosive gases (H₂S and CO₂) from both the riser and subsea pipeline. It is similar to that shown in FIG. 3, except for the recirculating fluid conduit 40 inlet 42 is connected to the pipeline further downstream and to a lower portion 16 of the pipeline, such as at a 6 o'clock position (bottom of the pipe). In this manner, the increased bolus of fluid flow is extended over a larger longitudinal distance of the pipeline. The amount of gas which enters the riser and subsea pipeline is determined based on the measured variations of the differential pressure. The time required to eliminate the gas from the system by fluid recirculation is determined using the data on differential pressure variations and software configured to predict gas pocket sweep out from oil pipelines.

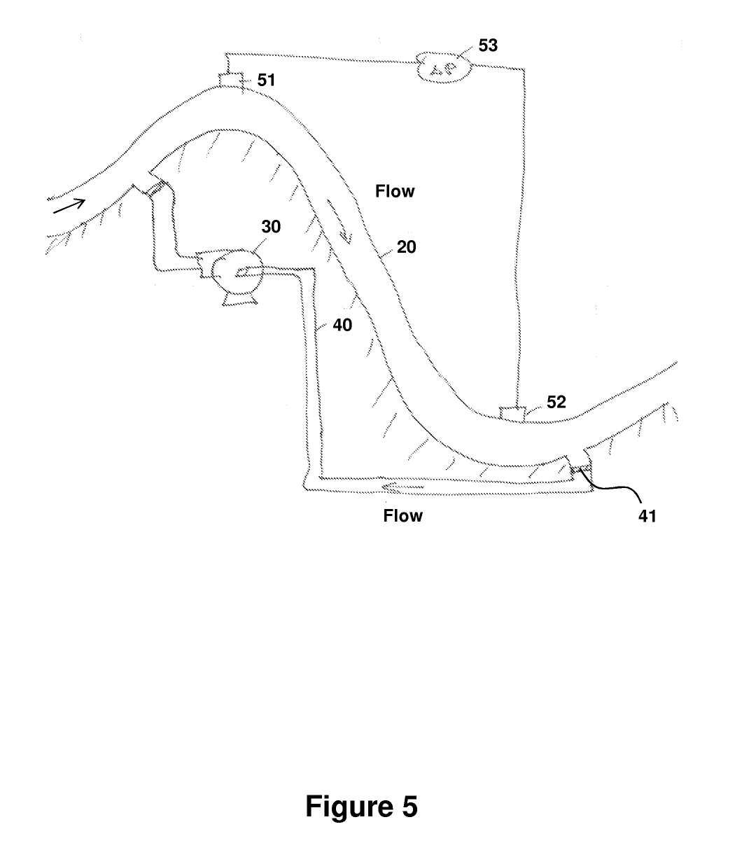

The application of the device and methods provided herein for an onshore pipeline is shown in FIG. 5. Recirculating fluid conduit 40 connects to the sections inclined upwards upstream and downstream of the inclined section 20 from which gas needs to be removed. The pressure sensors 51 and 52 are positioned at the upper and lower parts of the system. A portable pump 30 and flexible pipes can be used for recirculating fluid conduit 40. As desired, any flow control components may be used in the system to provide further flow control. For example, valve 41 is illustrated in the conduit 40.

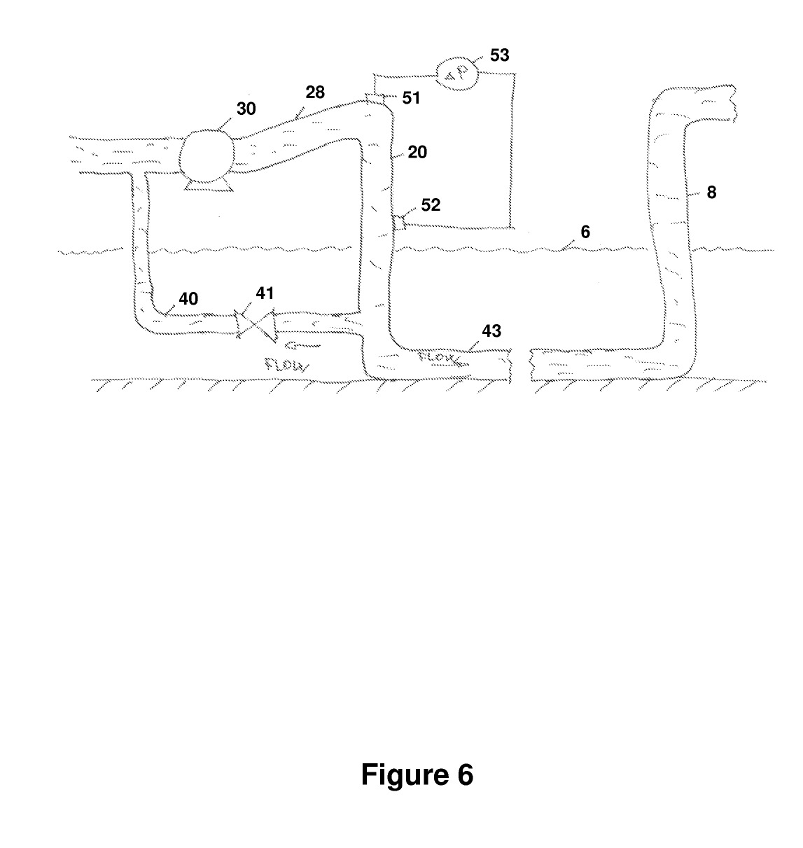

The system shown in FIG. 6 is similar to that summarized in FIGS. 3-5, except the pump 30 of FIGS. 3-5 is positioned in the pipeline and a valve 41 provides flow control through the recirculating fluid conduit 40. The system further comprises, a section inclined upwards, referred herein as a pipeline riser section 28 upstream of the export riser 20, pressure sensors 51 and 52, and differential manometer (transducer) 53. When the pressure difference measured by differential manometer 53 is less than hydrostatic pressure drop corresponding to the condition, at which the export riser is completely filled with liquid, the valve 41 opens and the flow rate through the shipping pump 30 increases to provide liquid recirculation and an increase in the flow velocity in the riser required to sweep out the accumulated gas. Once the measured pressure drop reaches the value corresponding to the liquid hydrostatic pressure drop, the shipping pump is turned off or at least decreased to decrease fluid flow rate through the shipping pump. The upward inclined section 28 minimizes gas bubble migration to facilities upstream of the system provided herein and to avoid pump cavitation.

### Example 2

### Pressure Drop Measurement in a Cross-Section of the Pipeline

Gas Removal System with Fluid Recirculation Using the Shipping Pump for Offshore Pipeline: System Description: The device (FIG. 7A) comprises of a fluid recirculating conduit 20, a valve 41, an upward inclined section 28, a horizontal section 24 connecting the section inclined upward with the export riser 20, pressure sensors 51 and 52 or 54, and differential manometer (transducer) 53. The fluid recirculating conduit returns part of the fluid flowing through the pipeline from the riser base or a point located at certain a distance downstream the export riser to the pump inlet. Flow recirculation occurs due to pressure difference between the pump outlet and inlet. Gas removal is achieved by increasing the local flow rate in the riser to sweep out gas bubbles. The flow rate of the recirculating fluid is controlled by two parameters: the pump power (or the pump speed) and the hydraulic resistance of the valve, which depends on its opening. The dashed lines between the pipeline and conduit 20 illustrates there is tolerance as to the precise location of the conduit inlet. If the system only requires removal of gas pocket 15a in the incline section 20, the inlet may be positioned closer to the incline section outlet. If other pockets of gas develop further downstream (15a 15b), the inlet may be positioned correspondingly further downstream the pipeline.

Gas pocket detection is used to engage or disengage the fluid recirculating system. When gas cannot flow downwards in the riser it accumulates and forms a large bubble occupying the entire section of the pipe, as illustrated by 15a. Gas bubble length increases until it reaches the riser base, i.e. the riser is packed with the gas. The liquid will flow in form of droplets and/or film formed on the pipe wall. Accumulated gas will also occupy the horizontal section connecting the upward inclined section 28 with the inlet end of the inclined section 21. This phenomenon can be used to detect the formation the large gas bubble. Pressure sensors 51 52 are installed at the top 17 and bottom 16 at the horizontal section 24 (see FIG. 7B) close to the bend joining sections 28 and 20. Gas accumulation produces a drop in the pressure head of the fluid that occupies the pipe cross section between two pressure sensors. Sensors are connected to a differential manometer or U-tube manometer (for applications with operating pressure below 400 psi). Alternatively, the second pressure sensor can be installed at the riser base, as illustrated by 54 and in this case it is possible to determine the length of the bubble in the riser, but the installation of this pressure sensor at the riser base is more challenging and costly to implement in the field. Other techniques such as a capacitance probe that measures in-situ liquid holdup in the horizontal section can also be used, or any combinations thereof.

The shipping pump 30 can be equipped with a variable frequency drive to change the pump speed and save energy consumption when the flow rate of transported liquid changes.

The gas detection system can automatically engage and disengage the fluid recirculation system. The gas removal system can also work without the gas detection system. In this aspect, it can be periodically turned on and off when the production liquid rate is lower than the predicted gas sweep out flow rate. Also, the flow rate of undissolved gas can be estimated to determine the system turn on and off frequency.

### Example 3

### Steady-State Flow Model for System Design and Operation

The gas removal system is a network of pipes, so the analysis of fluid-flow through the pipes is based on the mass conservation equations at junction nodes and energy conservation equations in loops of the network. The systems provided herein comprise two junction nodes, one closed loop, one source and one sink. In many cases, pressure at the import platform and pressure at the export platforms are specified and must be kept constant or within a certain range. The system of equations describing steady flow in the apparatus of the invention consists of the following three equations:

Equation 1. The sum of the produced liquid flow rate and recirculating fluid flow rates must be equal to the flow rate required to sweep out gas bubbles (the mass conservation equation):

qₚ+qᵣ=q_{b} (1)

Where qₚ=flow rate of produced liquid; qᵣ=flow rate of recirculated liquid; q_{b}=flow rate required to remove gas from the riser.

Equation 2. The net energy loss around the closed loop is zero:

ΔP_{P}(qₚ,qᵣ,ω)−ΔP_{R,f}(qₚ,qᵣ)+ΔP_{R,e}−ΔP_{RC,f}(qᵣ)−ΔP_{RC,e}−ΔP_{V}(qᵣ,δ)=0 (2)

Where ΔP_{P}=pressure rise in the shipping pump; ΔP_{R,f}=pressure drop due to friction in the export riser; ΔP_{R,e}=pressure drop due to elevation change in the export riser; ΔP_{RC,f}=pressure drop due to friction in the reciprocating conduit; ΔP_{RC,e}=pressure drop due to elevation change in the reciprocating conduit; ΔP_{V}=pressure drop across the valve; ω=pump speed; δ=valve opening.

In Eq. (2) hydrostatic pressure drops in the riser and in the recirculating conduit are equal, so it can be re-written as:

ΔP_{P}(qₚ,qᵣ,ω)−ΔP_{R,f}(qₚ,qᵣ)−ΔP_{RC,f}(qᵣ)−ΔP_{V}(qᵣ,δ)=0 (3)

Equation 3. For networks including reservoirs (sources or sinks with a constant pressure), an additional equation for a so called “pseudo loop” which connects two reservoirs can be written as:

Pₑₓₚ+ΔP_{P}(qₚ,q_{b},ω)−ΔP_{TP}(qₚ)=Pᵢₘₚ (4)

Where Pₑₓₚ=pressure at the pump inlet at the export platform; Pᵢₘₚ=pressure at the top of the riser at the import platform; ΔP_{TP}(qₚ)=pressure drop in the transfer pipeline.

In Eq.1, qₚ is known and q_{b} is calculated using relationships presented below. In Eq.3, ΔP_{P} and ΔP_{V} are calculated based on the characteristic curves of the pump and the valve, respectively, provided by their manufacturers. The calculation of ΔP_{R,f} and ΔP_{RC,f} is straightforward using the Darcy-Weisbah equation.

Substituting Eq. (1) into Eqs. (2) and (4) results in:

ΔP_{P}(qₚ,q_{b},ω)−ΔP_{R,f}(qₚ,q_{b})−ΔP_{RC,f}(qₚ,q_{b})−ΔP_{V}(qₚ,q_{b},δ)=0 (5)

Pₑₓₚ+ΔP_{P}(qₚ,q_{b},ω)−ΔP_{TP}(qₚ)=Pᵢₘₚ (6)

where the two unknowns are ω and δ. For a given liquid production rate, pressure at the export and import platforms, the required flow rate in the fluid recirculating conduit can be obtained by selecting a set of ω and δ values. The system of equations 5 and 6 can be used for the design and operation of the gas removal system.

Considering that the pressure due to friction in the riser and fluid recirculating conduits is much smaller that pressure rise in the pump and the pressure drop in the valve, the system of equations 5 and 6 can be rewritten as:

ΔP_{P}(qₚ,q_{b},ω)−ΔP_{V}(qₚ,q_{b},δ)=0 (7)

PₑₓₚΔP_{P}(qₚ,q_{b},ω)−ΔP_{TP}(qₚ)=Pᵢₘₚ (8)

The system of equations 7 and 8 can be used for estimating the principal parameters of any of the systems outlined herein, including for any general pipeline geometry.

Calculation of the flow rate to sweep-out gas from the riser: The liquid flow rate in the riser required to remove gas depends on the size of the bubbles in the riser. If bubbles are so large that they fill the entire cross-section of the pipe, e.g. the riser is completely filled with gas, the liquid velocity required to sweep out gas bubbles from the riser can by determined by the relationship by Dumitrescu 1943 “Strömung an einer Luftblase in senkrecthen Rohr” Z. angew. Math. Mech., 1943, vol. 23, no. 3, pp 139-149.

$${v}_{s} = 0.347 \sqrt{gD ( 1 - \frac{{ρ}_{g}}{{ρ}_{l}} )} \qquad ( 9 )$$

Where νₛ: rise velocity of large bubbles in the vertical pipe, m/s; D: inner diameter of pipe, m.

The gas sweep out velocity for small bubbles (bubble diameter is less that the pipe diameter) that rise in the continuous liquid can by calculated using the expression for the bubble-rise velocity proposed by Harmathy (Harmathy, T. Z.:“Velocity of Large Drops and Bubbles in Media Of Infinite or Restricted Extend” AlChE, no. 6, p. 281, 1960)

$${v}_{s} = {1.53 [ \frac{g {σ}_{L} ( {ρ}_{L} - {ρ}_{g} )}{{ρ}_{L}^{2}} ]}^{1 / 4} \qquad ( 10 )$$

where: νₛ=slip or bubble-rise velocity, m/s; ρ_{L}=liquid density, kg/m³; ρ_{g}=gas density, kg/m³; σ_{L}=surface tension, N/m; g=acceleration of gravity, m/s².

In summary, the guideline for selecting the expression for the calculation of the gas sweep out velocity is presented in Table 1

TABLE 1
Guideline for Selecting the Gas Sweep out Velocity

| | Gas Bubble Sweep out |
|---|---|
| Fluid in the riser | Velocity Formula |
| Gas | Dumitrescu |
| Liquid | Haramathy |

The flow rate is the product of the gas sweep out velocity and cross sectional area of the pipe.

$${q}_{b} = {V}_{s} \frac{π {D}^{2}}{4} \qquad ( 11 )$$

Calculation of the flow rate to sweep-out gas from the transfer pipeline: The calculation of the flow rate to sweep out gas from the transfer pipeline relies on the use of models of multiphase flow capable of reproducing the gas bubble formation in slightly inclined downward pipes.

Gas Removal System Using a Pump for Fluid Recirculation in Offshore Pipeline:

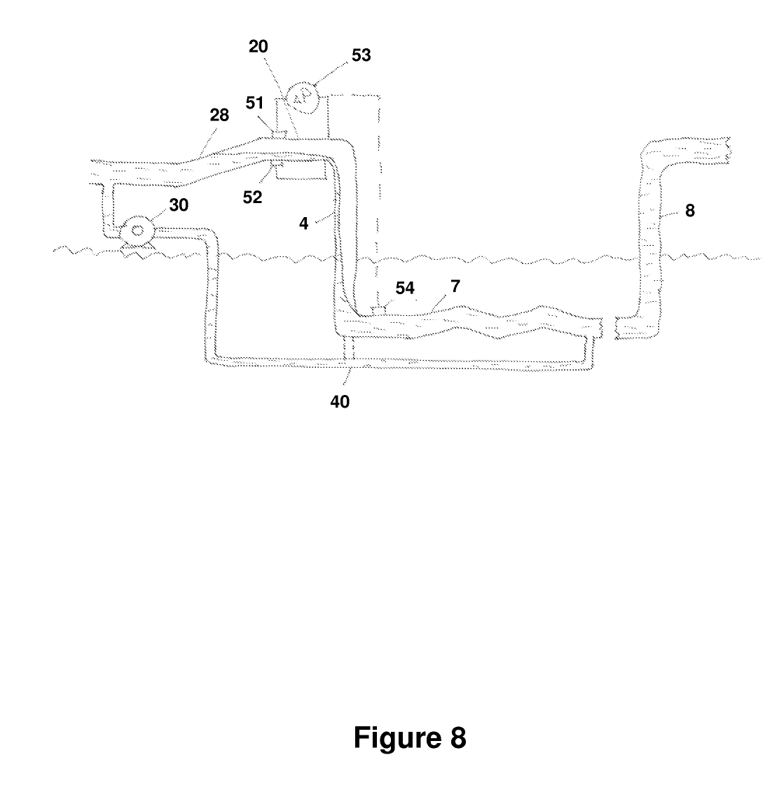

When the shipping pump cannot be used for fluid recirculation or when the pressure at the export platform is high enough to transport the liquid without pumping, a pump 30 installed into the recirculating conduit 40 may be used to increase the local liquid flow rate in the riser (FIG. 8).

The system operation is similar to that presented in the previously described example. The required pressure rise in the pump (or the pump speed) to reach the gas sweep velocity in the riser is calculated using the following equation for the closed loop:

−ΔP_{R,f}(qₚ,q_{b})−ΔP_{RC,f}(qₚ,q_{b})+ΔP_{P}(qₚ,q_{b},ω)=0 (12)

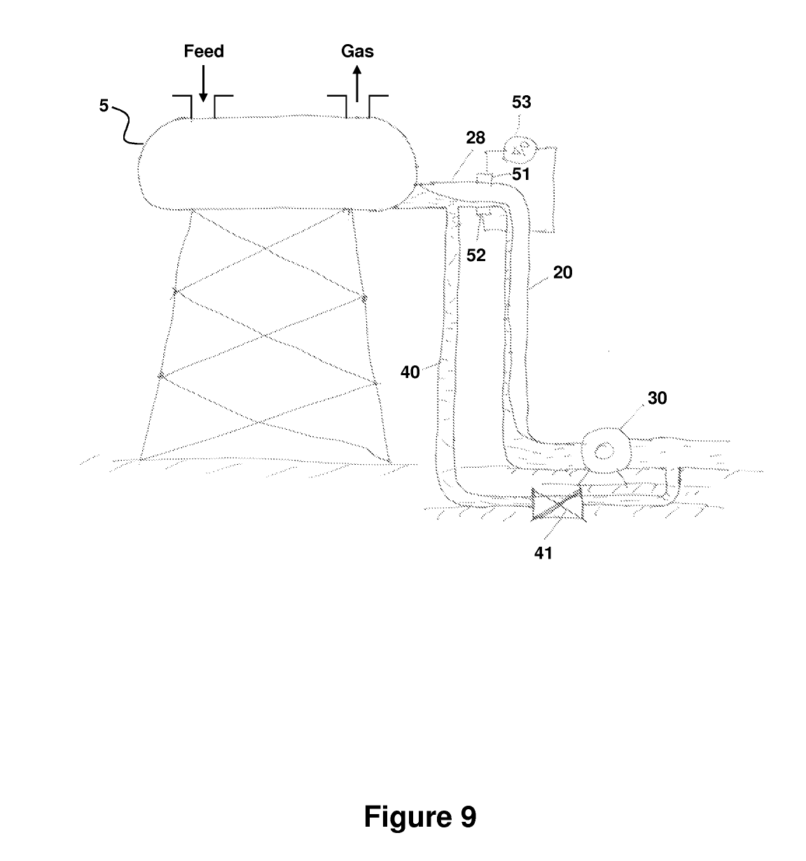

Gas Removal System for the Pipeline Transporting Liquid from an Elevated Separator or Tank: The system (FIG. 9) operation and equations for steady-state flow in it are the same as in the example presented above.

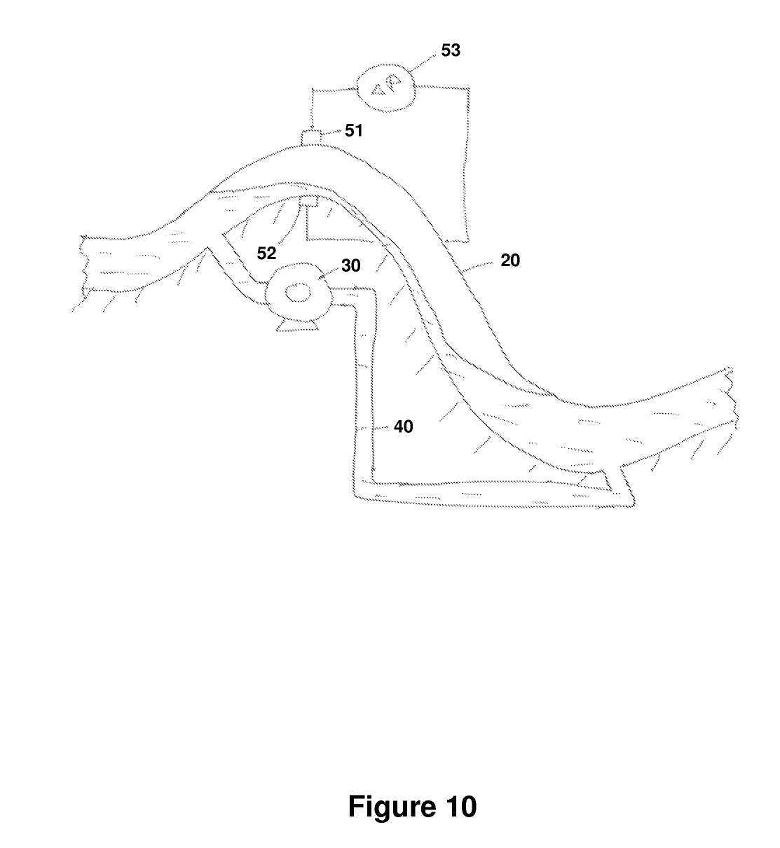

A System for Gas Removal from a Section of a Transfer Pipeline: The system (FIG. 10) operation and equations for steady-state flow in it are the same as in the example presented above.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a Markush group or other grouping is used herein, all individual members of the group and all combinations and subcombinations possible of the group are intended to be individually included in the disclosure.

Every formulation or combination of components described or exemplified herein can be used to practice the invention, unless otherwise stated.

Whenever a range is given in the specification, for example, a temperature range, a pressure range, a fluid velocity range, a size range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting” excludes any element, step, or ingredient not specified in the claim element. As used herein, “consisting essentially” does not exclude materials or steps that do not materially affect the basic and novel characteristics of the claim. In each instance herein any of the terms “comprising”, “consisting essentially” and “consisting” may be replaced with either of the other two terms. The invention illustratively described herein suitably may be practiced in the absence of any element or elements, limitation or limitations which is not specifically disclosed herein.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An apparatus for removing gas from a liquid hydrocarbon in an inclined section of a pipeline, the apparatus comprising:
a recirculating fluid conduit comprising:
an inlet connected to the pipeline at a downstream position relative to the inclined section;
an outlet connected to an upstream position relative to the inclined section;
a pump operably connected to the recirculating fluid conduit to provide a flow of recirculating fluid through the inclined section, wherein the recirculating fluid is provided from the pipeline to the recirculating fluid conduit inlet and introduced to the pipeline at the recirculating fluid conduit outlet;
a sensor operably connected to the inclined section for determining the presence or absence of a gas pocket in the inclined section;
wherein recirculating fluid is introduced to the pipeline from the recirculating fluid conduit in the presence of a gas pocket in the inclined section to increase flow-rate through the inclined section and to sweep away the gas pocket; and
wherein the pipeline is a liquid hydrocarbon transporting pipeline and the inclined section has a downwardly inclined configuration.

2. The apparatus of claim 1, wherein the pump is positioned in the recirculating fluid conduit for controlling a flow rate through the recirculating fluid conduit.

3. The apparatus of claim 1, wherein the pump is a shipping pump positioned in the pipeline that pumps a flow of a liquid hydrocarbon through the pipeline, the recirculating fluid conduit further comprising:
a valve to control a flow of recirculating fluid through the recirculating fluid conduit;
wherein the recirculating fluid conduit outlet is configured to provide the flow of recirculating fluid through the recirculating fluid conduit to an inlet of the shipping pump.

4. The apparatus of claim 3, wherein the pump is positioned between the recirculating fluid conduit outlet and the incline section of the pipeline.

5. The apparatus of claim 1, wherein each of the fluid inlet and fluid outlet are positioned flush with an inner surface of the pipeline.

6. The apparatus of claim 1, wherein the sensor is a first pressure sensor and the apparatus further comprises a second pressure sensor, wherein the first and second pressure sensors are positioned so that any gas pocket in the inclined section is captured in a pipeline region that is between the first and second pressure sensors.

7. The apparatus of claim 6, wherein the first pressure sensor is connected upstream of the inclined section and the second pressure sensor is connected at a point within the inclined section or at a position downstream of the inclined section.

8. The apparatus of claim 7, wherein:
the first pressure sensor is connected to an upper portion of the pipeline at an inlet end of the inclined section; and
the second pressure sensor is connected to or adjacent with an outlet end of the inclined section.

9. The apparatus of claim 6, wherein the first and second pressure sensors are positioned in an adjacent upstream region relative to the inclined section;
wherein the adjacent upstream region is substantially horizontal and fluidically connects a pipeline riser section with the inclined section; and
the first and second pressure sensors opposibly face each other with the first pressure sensor connected to a lower portion of the pipeline and the second pressure sensor connected to an upper portion of the pipeline and any gas pocket in the inclined section is at least partially trapped between the opposibly facing first and second pressure sensors.

10. The apparatus of claim 9, wherein the first and second pressure sensors are connected to a differential manometer or a U-tube manometer, and the pipeline has an operating pressure that is less than 400 psi.

11. The apparatus of claim 1, wherein the sensor is selected from the group consisting of: a pressure sensor; a flow sensor; a U-tube manometer; a capacitance probe; a manometer; and any combination thereof.

12. The apparatus of claim 1, wherein the sensor comprises a user-detected or calculated value of an operating parameter and a switch for turning the flow of recirculating fluid:
on when the user-detected or calculated value is less than a user-selected value of the operating parameter; or
off when the user-detected or calculated value is greater than a user-selected value of the operating parameter.

13. The apparatus of claim 12, wherein the operating parameter is selected from the group consisting of: liquid hydrocarbon flow rate through the pipeline; pressure difference between a first pressure sensor and a second pressure sensor; and in situ liquid hold-up.

14. The apparatus of claim 12 wherein the user-selected value is a calculated gas bubble sweep out velocity or flow rate and the user-detected value is a produced liquid hydrocarbon velocity or flow rate.

15. The apparatus of claim 1, wherein the sensor measures in-situ liquid holdup in a horizontal section of the pipeline that is upstream of the downward inclined section of the pipeline where a gas accumulates.

16. The apparatus of claim 15, wherein the in-situ liquid holdup is measured by a sensor that is a retractable capacitance probe.

17. The apparatus of claim 1, comprising a plurality of sensors to detect presence or absence of a gas pocket in the inclined section.

18. The apparatus of claim 1, further comprising an upward inclined section of pipeline between the recirculating fluid conduit outlet and the inclined section of pipeline to avoid gas pocket migration to an upstream facility.

19. The apparatus of claim 18, wherein the inclined section comprises a riser section and a substantially horizontal pipeline section, the horizontal pipeline section fluidically connects the riser section and the upward inclined section, wherein the substantially horizontal pipeline section is horizontal or has an inclination angle that is up to about −0.1° to confine any gas pocket to the inclined section.

20. The apparatus of claim 1, wherein the liquid hydrocarbon transporting pipeline is an offshore pipeline.

21. The apparatus of claim 1, wherein the liquid hydrocarbon transporting pipeline is an onshore pipeline.

22. The apparatus of claim 1, wherein the pipeline inclined section corresponds to a pipeline export riser or a pipeline import riser.

23. The apparatus of claim 1, wherein the pipeline has:
a diameter between 20 cm and 91 cm,
an upward inclined section inclination angle sufficient to provide an elevation change between an entry and an exit of the upward inclined section that is greater than the pipe diameter;
a pressure in the pipeline between 50 kPa and 1000 kPa; and/or
a fluid flow-rate of between 3500 bpd and 230000 bpd to remove a gas pocket.

24. The apparatus of claim 1, wherein at the outlet end of the inclined section the liquid hydrocarbon has a hydrostatic head, P_{H}, corresponding to:
P_{H}=ρgh,
wherein ρ is the fluid density, g is the acceleration due to gravity, and h is a vertical distance between the first and second pressure sensors.

25. The apparatus of claim 24, wherein a gas pocket is detected for a drop in pressure head compared to a no gas pocket condition, wherein the drop exceeds 10% of a minimum pressure head corresponding to the pipeline completely filled with liquid hydrocarbon.

26. The apparatus of claim 1, wherein the recirculating fluid increases flow-rate through the pipeline incline section by 20% to 30% compared to a flow-rate through the pipeline incline section when no gas pocket is present

27. The apparatus of claim 1, wherein a gas pocket in the pipeline to be removed has a volume selected from a range that is greater than or equal to 0.01 m³ and less than or equal to 23 m³.

28. The apparatus of claim 1, wherein upon gas pocket detection, the gas pocket is removed from the incline section at a removal time selected from a range that is greater than or equal to 60 seconds and less than or equal to 30 minutes.

29. The apparatus of claim 1, wherein the recirculating fluid conduit has:
a diameter that is greater than or equal to 10 cm and less than or equal to 30 cm;
a diameter ratio relative to the pipeline diameter: 0.3<(D_{conduit}/Dₚᵢₚₑₗᵢₙₑ)<0.8;
a length that is greater than or equal to 20 m and less than or equal to 150 m; and
a length ratio relative to the inclined section height: 1.2<(L_{conduit}/H_{incline})<4.

30. The apparatus of claim 1, wherein the recirculating fluid conduit is rigid and permanently connected to the pipeline and formed from a material selected from the group consisting of: stainless steel, carbon steel with a high density polyurethane internal coating, and corrosion resistant alloy.

31. A method for removing a gas pocket trapped in an inclined section of a liquid hydrocarbon transporting pipeline, the method comprising the steps of:
detecting a gas pocket in the inclined section;
introducing a flow of recirculating fluid to a recirculating fluid conduit, wherein the introduced flow of recirculating fluid is at a position downstream of the gas pocket; and
introducing the flow of recirculating fluid from the recirculating fluid conduit to the pipeline at a position that is upstream of the gas pocket to increase a flowrate through the inclined section, thereby removing the gas pocket from the inclined section.

32. The method of claim 31, wherein the detecting comprises:
calculating a predicted gas sweep out value rate;
observing a hydrocarbon liquid production rate; and
introducing the flow of recirculating fluid to the recirculating fluid conduit for a predicted gas pocket condition corresponding to an observed hydrocarbon liquid production rate that is less than a predicted gas sweep out value rate.

33. The method of claim 32, further comprising the step of:
stopping the flow of recirculating fluid the recirculating fluid conduit for a predicted no gas pocket condition corresponding to the observed hydrocarbon liquid production rate that is greater than or equal to the predicted gas sweep out value rate.

34. The method of claim 31, wherein the detecting comprises:
measuring a pressure in the inclined section; and
identifying a gas pocket in the inclined section when the measured pressure drop differs from a pressure drop corresponding to a no gas pocket condition by at least 10%; wherein the pressure drop corresponding to a no gas pocket condition is a pressure head whose value relates to the height of liquid in the pipeline above the location where the pressure is measured.

35. The method of claim 31, wherein the detecting comprises:
calculating a pressure drop across at least a portion of the inclined section by measuring a first pressure at a first pipeline position and a second pressure at a second pipeline position, wherein the second pipeline position is downstream from the first pipeline position; and
identifying a gas pocket present condition between the first and second pipeline positions when the calculated pressure drop deviates from an expected pressure head corresponding to ρgh by at least 10%, wherein ρ is the fluid density, g is the acceleration due to gravity, and h is the vertical distance between the first pipeline position and the second pipeline position.

36. The method of claim 31, wherein the recirculating fluid introduced into the pipeline increases a fluid flow-rate of fluid in the pipeline compared to a corresponding fluid flow-rate without introduced recirculating fluid by at least a factor of 1.2.

37. The method of claim 31, wherein the step of introducing the flow of recirculating fluid to a recirculating fluid conduit comprises:
opening a flow control valve in the recirculating fluid conduit; and
engaging a pump to flow recirculating fluid through the recirculating fluid conduit and into the pipeline at the position upstream from the inclined pipeline section.

38. The method of claim 37, wherein the pump is positioned in the recirculating fluid conduit.

39. The method of claim 37, wherein the pump is positioned in the pipeline and downstream of the introduced flow of recirculating fluid from the recirculating fluid conduit to the pipeline.

40. The method of claim 31, further comprising the step of confining any gas pocket in the pipeline by providing a section of pipeline that is inclined upward, wherein the inclined upward pipeline section has an upper-most portion positioned between the point at which the flow of recirculating fluid from the recirculating fluid conduit is introduced to the pipeline and an upper-most portion of the inclined section pipeline.

41. The method of claim 31, wherein the pipeline is an offshore pipeline.

42. The method of claim 31, wherein the pipeline is an onshore pipeline.

43. The method of claim 31, wherein the inclined section is an export riser or an import riser having a vertical height that is greater than or equal to 10 m and less than or equal to 120 m.

44. The method of claim 31, wherein the recirculating fluid conduit has a length that is greater than or equal to 20 m and less than or equal to 400 m.

45. The method of claim 32, wherein the calculated gas sweep out value rate is:
$${v}_{s} = 0.347 \sqrt{gD ( 1 - \frac{{ρ}_{g}}{{ρ}_{l}} )}$$
for a gas pocket that fills an entire cross-section of the pipeline; or
$${v}_{s} = {1.53 [ \frac{g {σ}_{L} ( {ρ}_{L} - {ρ}_{g} )}{{ρ}_{L}^{2}} ]}^{1 / 4}$$
for a gas pocket having a size that is less than a diameter of the pipeline;
wherein νₛ is the gas sweep out value rate (m/s), g is the acceleration due to gravity (m/s²), D is the diameter of the pipeline interior (m), ρ_{g} is gas density (kg/m³), ρₗ is liquid density (kg/m³), and σ_{L} is surface tension; and the flow rate, q_{b}, through the inclined section is selected to be greater than or equal to: vₛ*(πD²/4), wherein at least a portion of the flow through the inclined section is from the recirculating fluid conduit.

46. A method of installing an apparatus for removing gas from an inclined section of a liquid hydrocarbon transporting pipeline into a liquid hydrocarbon transporting pipeline, the method comprising the steps of:
providing a recirculating fluid conduit having a first end and a second end;
connecting the first end of the recirculating fluid conduit to the pipeline at a position upstream of the inclined section;
connecting the second end of the recirculating fluid conduit to the pipeline at a position downstream of the inclined section;
providing at least one pressure sensor to measure pressure in the pipeline, wherein the measured pressure indicates the presence or absence of a gas pocket in the inclined section; and
providing a flow-controller to control a flow-rate of recirculating fluid through the recirculating fluid conduit.

47. The method of claim 46, wherein the flow-controller comprises a pump that controls the flow-rate of recirculating fluid through the recirculating fluid conduit.

48. The method of claim 46, wherein the flow controller is operably connected to an output of the pressure sensor to:
automatically generate recirculating fluid flow through the recirculating fluid conduit when the measured pressure in the pipeline deviates from a user-selected tolerance value; and
automatically stop recirculating fluid flow through the recirculating fluid conduit when the measured pressure in the pipeline is within a user-selected tolerance value.

49. The method of claim 48, wherein the tolerance level corresponds to a measured pressure that is within 10% of a pressure for a no gas pocket condition.

50. The method of claim 46, further comprising installing an inclined upward section of pipeline between first end of the recirculating fluid conduit and the inclined section of the pipeline to confine any gas pockets to a pipeline region that is downstream from the first end of the recirculating fluid conduit.

51. The method of claim 46, wherein the pipeline is an offshore pipeline.

52. The method of claim 46, wherein the pipeline is an onshore pipeline.
